(19) United States
(12) Patent Application Publication
(10) Pub. No.: US 2022/0381216 A1
(43) Pub. Date: Dec. 1, 2022

(54) Hydroelectric turbine for generating electricity by converting energy of ocean waves

(71) Applicant: Robert Bado, Delray Beach, FL (US)

(72) Inventors: Robert Bado, Delray Beach, FL (US); Artem Madatov, North Bethesda, MD (US)

(73) Assignee: Robert Bado, Delray Beach, FL (US)

(21) Appl. No.: 17/332,475

(22) Filed: May 27, 2021

(51) Int. Cl. F03B 3/18; F03B 3/04; F03B 3/12; F03B 13/22

(52) U.S. Cl. CPC F03B 3/18; F03B 3/04; F03B 3/126; F03B 13/22; F05B 2240/13

(57) ABSTRACT

A hydroelectric turbine designed to operate in a bi-directional reversing water flow caused by ocean waves, comprising an annular stator with two axially spaced sets of a plurality of guide vanes placed along its circumference that are inclined in the axial direction, an annular rotor with a plurality of concavo-convex blades placed along its circumference with an electric generator attached to it. The rotor is placed to rotate about its axis between the two sets of the stator guide vanes. Wherein, the stator and rotor are placed within the cylindrical part of an hourglass-shaped double funnel so when the ocean wave moves in one direction, the water flow enters the turbine through one end of the double funnel (inlet) and passes through the channels formed by one of the stator guide vane sets towards the rotor blades. The channels formed by the stator guide vanes are inclined at an angle to the rotor rotation plane, so that the water flows in the direction of the rotor rotation. After passing through the channels formed by the rotor blades and the channels formed by the other set of the stator guide vanes the water flows out of the turbine through the opposite end of the double funnel (outlet). When the wave moves in the opposite direction and the water flow direction reverses accordingly, the outlet becomes the inlet and the inlet becomes the outlet. The turbine keeps rotating in the same direction, transmitting the rotation to the electric generator and providing continuous high efficiency energy conversion.

### FIELD OF THE INVENTION

This invention relates to an alternative energy source, more specifically conversion of the energy of ocean waves into electricity.

### BACKGROUND OF THE INVENTION

Every continent on the planet is surrounded by a cleaner, safer, more efficient answer to our energy needs. The ocean holds a tremendous amount of untapped energy.

Ocean energy comes in a variety of forms such as marine currents, tidal currents, geothermal vents, offshore wind and waves. Wave energy is generally considered to be the most concentrated form of renewable energy.

Wave energy provides 15-20 times more available energy per square meter than either wind or solar. It is the high power density of wave energy that suggests it has the capacity to become the lowest cost renewable energy source. As water is approximately 800 times denser than air, the energy density of waves vastly exceeds that of wind, dramatically increasing the amount of energy available for harvesting. Wave energy is a genuinely renewable, zero-emission energy source.

Water particles near and on the surface of ocean waves have trajectories close to circular. Thus a floating body moves up and down with each wave cycle. This up and down motion can be transmitted to an electric generator in one way or another.

There are several known attempts to use linear reciprocating electric generators for converting energy of ocean waves into electricity. However, the technology has some drawbacks in terms of weight and costs. One of the most challenging aspects of the application of a linear electric generator in a wave energy converter is clearly to meet the low speed/high force characteristics of the device because of the wave period ranging from several seconds to several tens of seconds, resulting in high oscillation period of the generator armature. Such generator must have high stator inductance, respectively has a large number of stator coils and is too expensive to manufacture.

The conversion of the reciprocating motion of the waves into the rotational motion of a standard electric generator also presents certain technical difficulties.

The commonly used principle of motion conversion is to transform the reciprocating motion into a unidirectional rotation by means of valves or ratchets: either hydraulic, pneumatic, or mechanical. OPT wave energy converter is one of the examples of linear reciprocating hydraulic converters www.oceanpowertechnologies.com.

The oscillating water column is yet another type of wave energy converters that was developed and deployed at sea, and is one of the most successful motion conversion technologies. The device comprises a partly submerged concrete or steel chamber, fixed or floating, and open below the water surface, wherein air is trapped inside above the water surface. The oscillating motion of the water surface inside the chamber caused by the waves makes the air flow through a turbine that drives an electric generator. One of the first and successful designs of the oscillating water column converters was the Masuda oscillating column.

Due to the fact that the energy of ocean waves is first converted into the energy of a liquid or gaseous working medium, the linear reciprocating converters have low efficiency, low reliability, high cost, potential ecological impact and complex manufacturing process. That is why the attempts to convert the energy of ocean waves directly into rotational energy by using turbines continue.

### DESCRIPTION OF THE PRIOR ART

In the development of oscillating water power converters, the focus has been on the use of Wells type turbines, which are self-rectifying and can operate and generate electricity in a reversing bi-directional air flow. The Wells turbine, manufactured in the late 1970s by professor Alan Arthur Wells at Queen's University Belfast, is a bilateral turbine that uses symmetrical airfoils. The airfoils will rotate the same direction in spite of the direction of water flow. The Wells turbine has both advantages and limitations. The advantages are that it has no moving parts other than the main water turbine rotor, making it easier to operate and maintain and more cost beneficial. But some limitations occur i.e. some inefficiency at high airflow rates because the airfoil's high angle of attack creates more drag.

One such turbine is described in the U.S. Pat. No. 8,678,745B2.

In theory, such turbines can operate at high efficiencies in excess of 50% under steady-state flow conditions. However, they operate effectively only within a relatively small range of water flow rates and therefore can only operate effectively within a relatively small range of wave conditions. In addition, the Wells turbines typically operate at relatively high rotational speed and low torque, comparing to, for example, impulse turbines, and have relatively high axial loads, all of which is undesirable in an oscillating water column power generation unit.

There is a known turbine, designed by one of the present inventors, operating directly in the reversible water flow caused by ocean waves, according to the patent of Ukraine UA103531 (Analog of the present invention).

Due to the use of pivoting blades, this turbine is self-rectifying and always rotates in the same direction regardless of the water flow direction. The automatic mechanism for changing the angle of attack of the blades is based on the difference of water pressure on the leading and trailing edges of each blade. The profile of the turbine blades is symmetrical and water alternately presses on the upper and lower surfaces of the blades. Changing the angle of attack of the blades to an opposite angle when the direction of water flow changes, creates a unidirectional torque. It is known, however, that asymmetric (concavo-convex) turbine blades give the best efficiency of flow energy conversion.

The disadvantages of this turbine with pivoting blades include: relatively low efficiency, manufacturing complexity, relatively high installation and maintenance cost, excessive axial load, and excessive load on the pivoting nodes and blade retainers. To eliminate these disadvantages, it is necessary to simplify the design of the turbine and transfer the force of water pressure from the turbine's rotor to the stationary parts, namely the guide vanes of its stator.

There is a known impulse turbine for use in bi-directional flows as described in the United States patent US20140056691A1 (Prototype of the present invention).

The turbine arrangement may include a rotor rotatably mounted to rotate about an axis of the turbine arrangement, and the rotor may have a plurality of rotor blades disposed circumferentially thereabout. A first set of guide vanes may be circumferentially disposed about the axis for directing the bi-directional reversing flow to and from the rotor blades via a first flow passage defined by a first duct. A second set of guide vanes may be axially spaced from the first set of guide vanes and circumferentially disposed about the axis for directing the bi-directional reversing flow to and from the rotor blades via a second flow passage defined by a second duct. The guide vanes may be disposed at a greater radius than the rotor blades, such that the guide vanes are radially offset from the rotor blades. Thus, the guide vane is radial in this turbine.

The height of the annular flow passage of the first and second annular ducts may be constant along the length of the annular ducts. Alternatively the height of the annular flow passage of the first and second annular ducts may vary and in particular reduce at an end of the duct adjacent the rotor blades. Such a variation in the duct height will advantageously vary the angle of the flow to and from the guide vanes that is then directed to the rotor blades so reducing the required turning angles of the rotor and/or guide vanes. This may then reduce the losses associated with the downstream flow from the rotor over the guide vanes during a reverse flow over the guide vanes.

The disadvantages of the prototype include the complex part shapes resulting in high material content that affects the turbine's weight and manufacturing complexity. Thus, the production cost is high.

### SUMMARY OF THE PRESENT INVENTION

In order to increase the hydroelectric turbine's efficiency in a bi-directional reversing water flow and to simplify the manufacturing process, making it cost-effective, the present inventors combined the following features in this device:

An annular stator and an annular rotor, which rotates about its axis between the two sets of the stator guide vanes, within a cylindrical part of an hourglass-shaped double funnel, made of two identical oppositely oriented hollow truncated cones joined by a cylinder, to which water flows alternately through its opposite ends, enabling the turbine's operation in the bi-directional reversing water flow. Therefore, when the water flows in one direction, the first end of the double funnel is an inlet, and the opposite end is an outlet, and when the direction of flow reverses, the first end becomes the outlet, and the opposite end becomes the inlet. The water through the opposite sides of the funnel alternately passes between the two mirror-symmetrical sets of the stator guide vanes and the rotor blades.

The annular stator's guide vanes are flat, inclined in the axial direction, and placed in two axially spaced sets along its circumference. This simplified geometry results in cost saving manufacturing simplicity and assures that the pressure of the passing water flow has a direction perpendicular to the plane of the stator guide vanes. Thus, the axial force of the pressure falls on the stator guide vanes (the stationary part of the turbine), and not on the turbine rotor and bearings.

The guide vane arrangement in two axially spaced sets along the stator circumference is mirror-symmetrical with respect to the rotor's plane of rotation, enabling its unidirectional rotation while the turbine operates within the bi-directional reversing water flow.

The turbine rotor blades have an optimal concavo-convex shape that is symmetrical with respect to the rotor's plane of rotation, enabling its unidirectional rotation. This significantly increases the efficiency of the turbine.

The turbine can be manufactured using a variety of materials, including but not limited to metals, plastics and composites.

### BRIEF DESCRIPTION OF THE DRAWINGS

FIG. 1 is a cross-section isometric view of the hydroelectric turbine, showing the present invention in detail.

FIG. 2 is a detailed isometric view of the turbine's rotor.

FIG. 3 is a detailed cross-section isometric view of the turbine's stator.

FIG. 4 is a more detailed cross-section isometric view of the turbine, including the full rotor/stator assembly, as well as showing a relative position of the stator's guide vanes and the rotor's concavo-convex blades with passing water through the stator and rotor.

FIG. 5 is an isometric view of the hourglass-shaped double funnel of two identical oppositely oriented hollow truncated cones joined by the hollow cylinder.

FIG. 6 is an isometric view of the fully assembled turbine attached to the bottom anchors, showing all applied forces relevant to the turbine's operation.

FIG. 7 is a detailed isometric view of the turbine's stator and rotor, showing a relative position of the stator's guide vanes and the rotor's blades, illustrating the passage of water through the channels formed by the guide vanes and the blades respectively during the up and down motion of the water through the turbine, as well as the forces applied to the rotor blades.

FIG. 8 is a cross-section isometric view of the hydroelectric turbine's alternative embodiment with the integrated electric generator.

FIG. 9 is an isometric view of the fully assembled turbine equipped with the dynamic brake, showing all applied forces relevant to the turbine's operation.

FIG. 10 shows wave energy distribution and water movement depending on depth.

FIG. 11 is an isometric view of the reactive turbine component of the hydroelectric turbine, illustrating the reactive turbine operating principle, as well as the torque created by the water jets caused by the reactive turbine.

FIG. 12 is an isometric view of the hydroelectric turbine with the attached reactive turbine component.

### DETAILED DESCRIPTION OF THE PRESENT INVENTION

The invention is a device, referred to as a hydroelectric turbine, for generating electricity within a bi-directional reversing water flow caused by ocean waves.

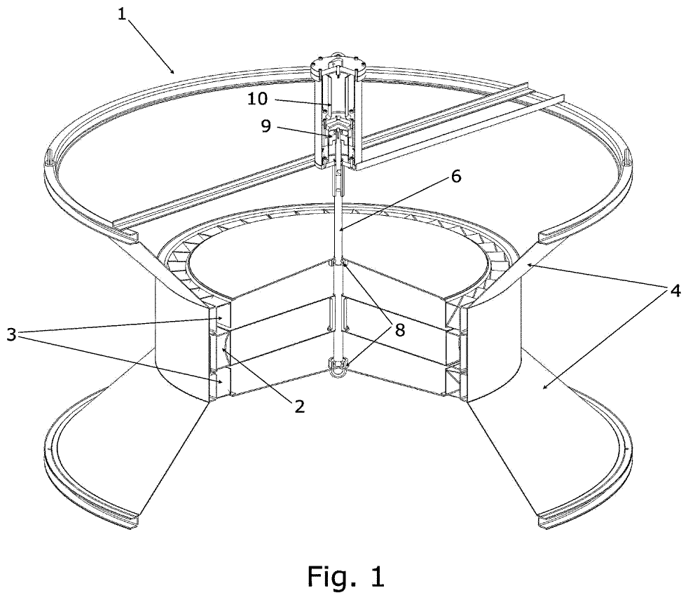

In the preferred embodiment as shown in the FIG. 1, the hydroelectric turbine (1), comprises an annular rotor (2) that is placed to rotate about its axis, an annular stator (3), wherein the stator and rotor assembly is placed within a narrow cylindrical part of an hourglass-shaped double funnel (4) made of two identical oppositely oriented hollow truncated cones joined by a hollow cylinder with a diameter equal to the diameter of the truncated cone's top.

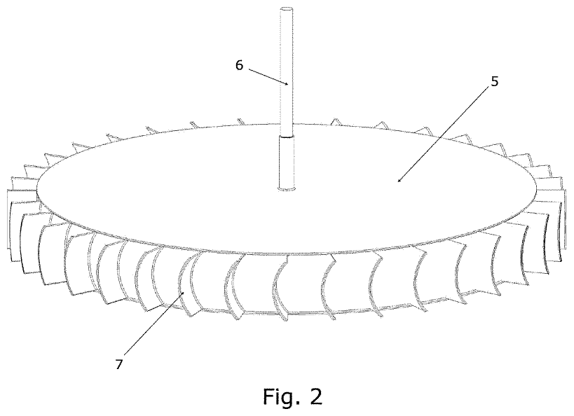

The turbine rotor (2) comprises a hollow sealed cylinder (5) rigidly affixed to the shaft (6) and a plurality of concavo-convex blades (7), having a profile that can in general be described as a sector of a thin-walled hollow cylinder, rigidly affixed to the outer lateral wall of the cylinder (5) along its circumference in perpendicular to the axis of rotation, thus the blade's profile is symmetrical with regards to the rotor's plane of rotation (FIG. 2). Wherein, the height of the blade (7) and the cylinder (5) is about the same.

The diameter of the cylinder (5) is selected to be about 90% and the width of the rotor blade (7) to be about 5% of the inner diameter of the turbine stator (3), thus making the full rotor assembly diameter equal to about 100% of the inner diameter of the stator (3).

The shaft (6) is securely placed and rotates in the water-lubricated bearings (8), and the torque from the rotating shaft (6) is transmitted via the magnetic coupling (9) to the hermetically sealed electric generator (10) (FIG. 1).

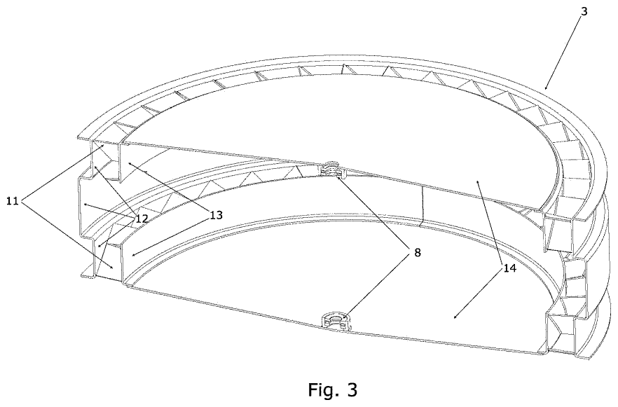

The turbine's annular stator (3) comprises two axially spaced mirror-symmetrical sets of a plurality of guide vanes (11), rigidly affixed to the inner lateral surface (12) of the stator (3) along the stator's circumference, and extending between the stator's inner lateral surface (12) and the inner rim (13), inclined at an angle of about 45° to the rotor's rotation plane (FIG. 3). The indicated angle value is not meant to be limiting and can vary within a range that allows to accomplish a desired goal. Two oppositely oriented cone-shaped deflectors (14) rigidly affixed by the edge of their base to the outer edge of the inner rims (13) on the opposite ends of the stator (3), resulting in water being deflected and flowing towards the guiding channels formed by the stator guide vanes (11) during the up and down motion of the water through the turbine. This is done to substantially increase the water flow rate through the rotor (2). Such arrangement provides optimal efficiency in the absence of swirling. In the preferred embodiment the thrust bearings (8) are affixed to the inner surface of each deflector (14) as shown in the FIG. 3.

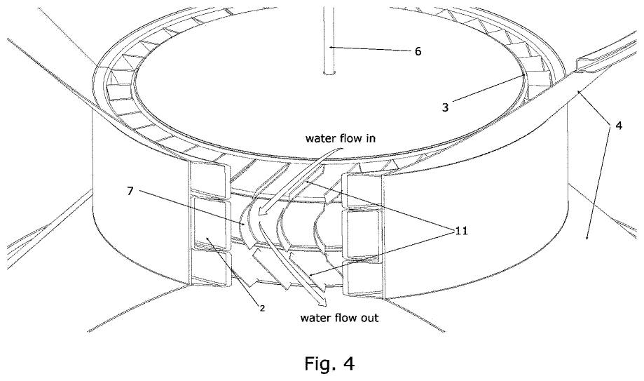

The rotor (2) is so positioned along the axis on the shaft (6) that its concavo-convex blades (7) are located and rotate between the two sets of the stator guide vanes (11) (FIG. 4).

Wherein, placed inside the cylindrical part of the hourglass-shaped double funnel (4) the stator (3) and the rotating between its mirror-symmetrical sets of the guide vanes (11) concavo-convex blades (7) of the rotor (2), so when the ocean wave moves in one direction, the water flow enters the turbine through one end of the double funnel (4) (inlet) and passes through the channels formed by one of the stator guide vane sets (11) towards the rotor blades (7). The channels formed by the stator guide vanes (11) are inclined at an angle to the rotor rotation plane, so that the water flows in the direction of the rotor rotation. After passing through the channels formed by the rotor blades (7) and the channels formed by the opposite set of the stator guide vanes (11) the water flows out of the turbine through the opposite end of the double funnel (4) (outlet). When the wave moves in the opposite direction and the water flow direction is reversed accordingly, the outlet becomes the inlet and the inlet becomes the outlet. The rotor (2) keeps rotating in the same direction (FIG. 4).

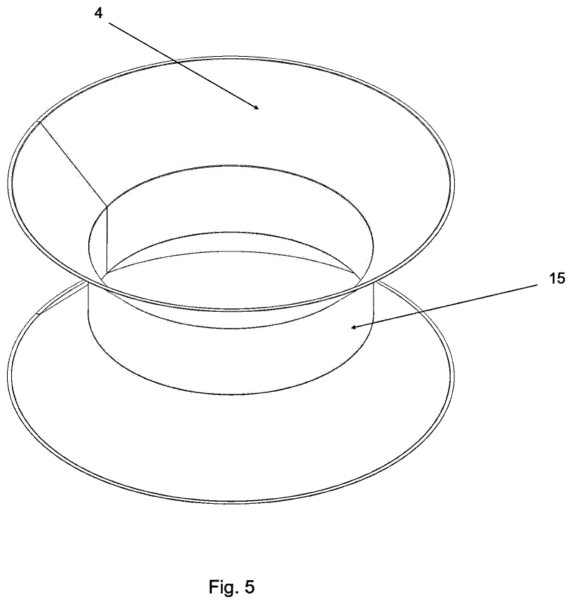

The hourglass-shaped double funnel (4) of two identical oppositely oriented hollow truncated cones joined by the hollow cylinder (15) with a diameter equal to the diameter of the truncated cone's top and the length equal to or slightly longer than the height of the stator (3), wherein a height of each truncated cone is selected to be slightly more than a half of the average wave amplitude at the turbine's installation site, so the volume of water captured by each half of the double funnel (4) will be maximum and, at the same time, the height and weight of the turbine will not be excessive (FIG. 5). The diameter of each double funnel (4) half's (each truncated cone's) base is so chosen that its volume has enough time to fill with water within the time equal to the average half wave period at the turbine's installation site. The described and shown configuration of the double funnel (4) is not meant to be limiting, as other configurations and dimensions are possible provided the assembly accomplishes the defined goals. Alternatively, each truncated cone of the double funnel (4) can be of adjustable height and base diameter in order to adapt to a variety of wave conditions.

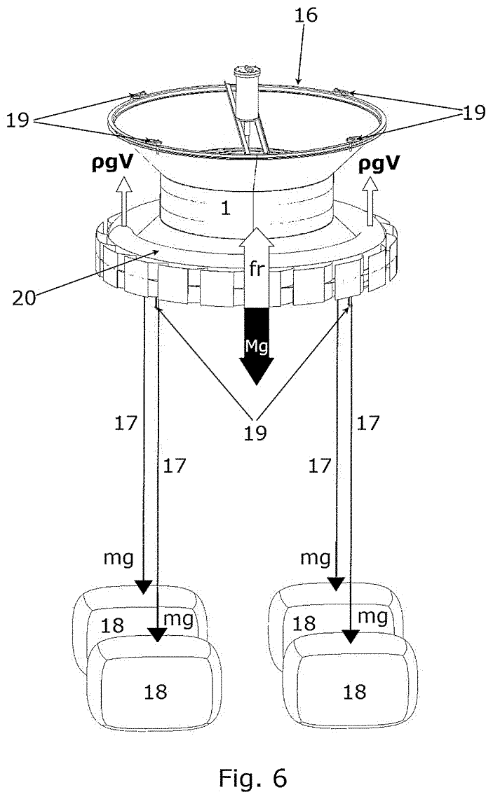

Due to the turbine operating at or near the ocean surface, it is a subject to possible significant destructive forces of wind and waves. Therefore, the turbine (1) is secured by the rigid load-bearing housing or frame (16) as shown in the FIG. 6. The resistive force of the anchors (18) is applied through the anchor ropes (17) to the lower part of the turbine's frame (16) which is equipped with eye bolts (19) at the top and bottom for lifting and anchoring. The described and shown configuration of the frame is not meant to be limiting.

Since the turbine designed to operate at or near the ocean surface, the entire assembly is kept afloat by the float (20), which is torus-shaped in its preferred embodiment and made of a variety of materials serving the purpose, including the variable buoyancy foams, inflatable annular plastic or rubber tubes (FIG. 6). It is highly desirable to have an adjustable buoyancy of the turbine so it remains operational and efficient in relatively small waves.

The turbine operating principle is based on the passage of water through it, provided that a phase difference occurs between the oscillations of the surface waves and the turbine.

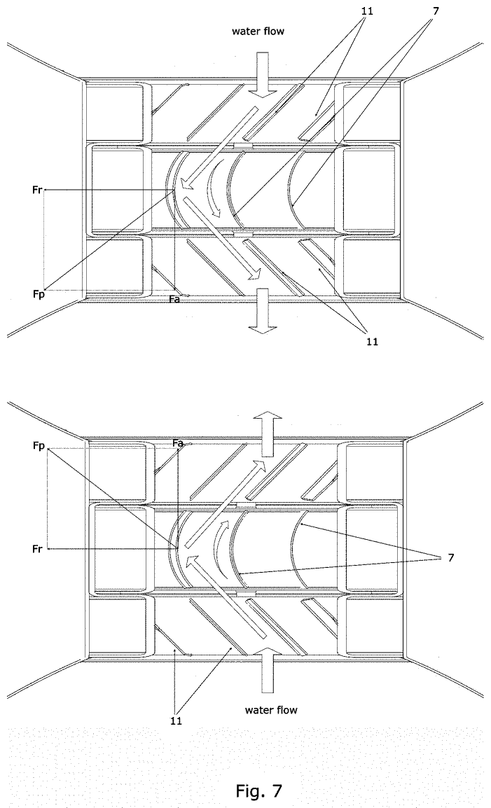

If the turbine (1) is attached by the anchor ropes (17) to the bottom anchors (18) (FIG. 6), and the weight of the anchors (18), equal to mg, is much greater than the sum of the maximum buoyancy μgV and the turbine drag force through the water fr, and the buoyancy force exceeds the weight of the turbine (1) filled with water Mg, then the turbine (1) always remains in a stationary vertical position relative to the ocean floor (FIG. 6). In this case, the phase difference between the turbine (1) and the water surface oscillations is 180°, and the movement of water relative to the turbine (1) is in antiphase. When the surface of the wave moves upward towards its crest, the water moves through the lower half of the double funnel (4) (lower truncated cone) upward according to the law of communicating vessels. The upward moving water flow being deflected by the lower cone-shaped deflector (14) towards the lower set of the stator guide vanes (11), and through the guiding channels formed by them, passes towards the turbine rotor blades (7). The stream of water applies pressure to the concave surface of the turbine rotor blades (7) with a pressure force Fp (FIG. 7). The projection of the pressure force Fp along the turbine axis Fa is compensated for by the equal resistive force of the thrust bearings (8) of the turbine rotor (2) and does not produce work. The projection of the pressure force Fp onto the plane of rotation is the force Fr that applies to a concave surface of each blade (7), pushes it along this plane of rotation and produces work. The turbine rotor (2) with a plurality of blades (7) along its circumference, under the action of the forces Fr, performs a rotational motion around its axis and creates a torque. The water flow, passing between the concavo-convex rotor blades (7), transfers energy to the rotor (2), reflects from the concave surface of the blade (7), changes the direction by about 90° and flows through the guiding channels formed by the upper set of the stator guide vanes (11) into the upper half of the double funnel (4) (upper truncated cone). The upper truncated cone of the double funnel (4) in this phase serves as an outlet and is being filled with water until the wave reaches its crest. In the next half-period of the wave cycle the wave moves downward. The turbine (1) is being held in place by the Archimedean force μgV. According to the law of communicating vessels by the force of gravity, water from the upper truncated cone of the double funnel (4) (now the inlet) flows in opposite direction (downward) through the guiding channels formed by the upper set of the stator guide vanes (11) towards the rotor blades (7). In this case, the water flow (FIG. 7) pushes the concavo-convex rotor blades (7) and thus the rotor (2) in the same direction as in previous phase. The projection of the pressure force Fr on the plane of rotation is still directed in the same direction and rotates the rotor (2) in the same direction. After completing the work, the water flow changes its direction by about 90° and flows between the lower set of stator guide vanes (11) into the lower truncated cone of the double funnel (4) (now the outlet) until the wave reaches its trough. Then the cycle repeats. The rotor (2) continues rotating all the time in the same direction, regardless of the direction of the water flow through the turbine (1). This, together with the buffer capacity of the double funnel (4), provides a significantly higher efficiency of energy conversion and reduces fluctuations in the angular speed of rotation of the rotor (2).

Alternatively, the shaftless turbine embodiment is possible. In this case, the turbine's rotor (2) and stator (3) become integral parts of a bearing set, that can be achieved by means of using one of the available water lubricated anti-friction technologies, e.g. a more traditional ball or roll annular thrust bearing, marine bearing plate and journal sets, or permanent magnetic annular thrust bearing sets.

In the preferred embodiment as shown in the FIG. 1, the torque from the turbine rotor (2) is transmitted through the magnetic coupling (9) to the hermetically sealed in the waterproof casing electric generator (10).

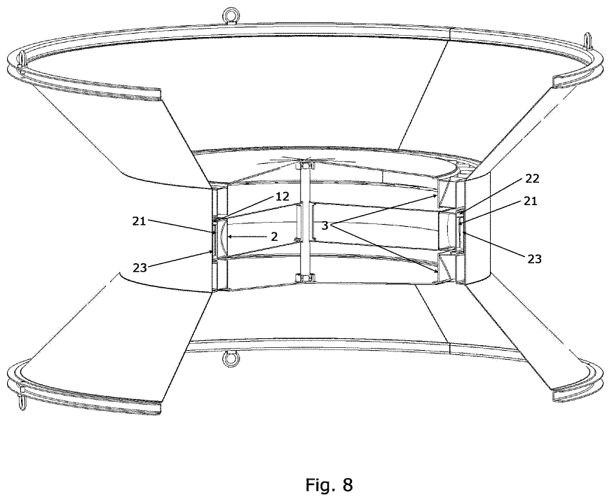

Alternatively, as shown in the FIG. 8, the turbine stator (3) and the turbine rotor (2) serve as a stator and a rotor of an integrated electric generator respectively, that can be accomplished by affixing a plurality of magnets (21) along the outer lateral surface of the turbine rotor's outer rim (22) and placing a plurality of coils (23) along the inner lateral surface (12) of the turbine stator, thus the turbine rotor (2) and the turbine stator (3) effectively become the rotor and the stator of the electric generator respectively. The magnets (21) and the coils (23) are fully encapsulated in the salt water and corrosion resistant material as epoxy, resin, plastic, non-magnetic metal or similar material that does not interfere with the electromagnetic fields. Rotation of the rotor (2) moves the magnets (21) across the coils (23) thus generating the electricity.

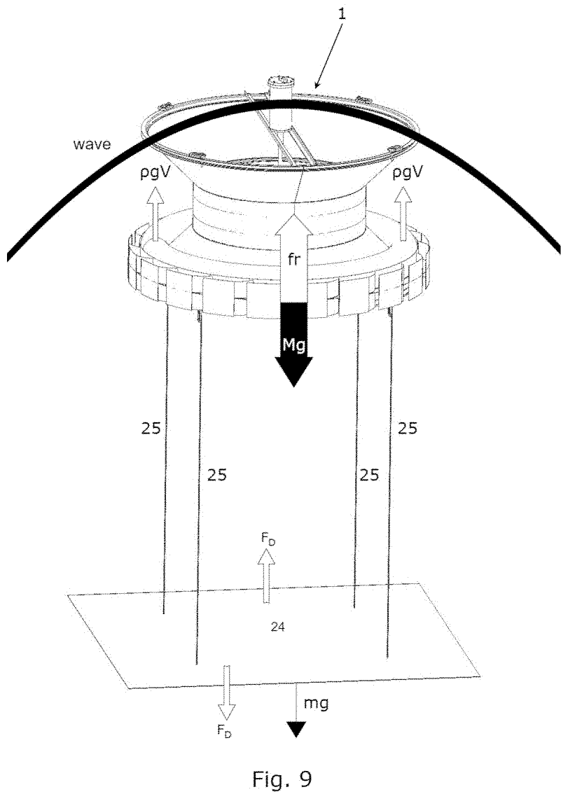

In the case when the ocean depth is too great to anchor the turbine (1), or such anchoring is impossible or undesirable for other reasons, a dynamic brake is used to create the phase difference between the turbine and ocean waves (FIG. 9). This dynamic brake (24) is a body with the highest drag coefficient. The drag force acts in a direction that is opposite of the relative water flow velocity

F_{D}=½ρv²C_{D}A

F_{D}=drag force

ρ=fluid density

v=speed of the object relative to the fluid

C_{D}=drag coefficient

A=cross sectional area

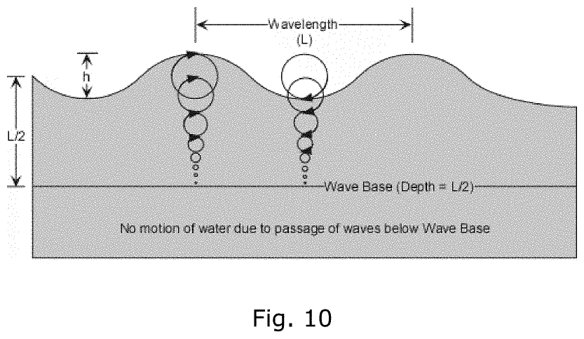

In the preferred embodiment, the dynamic brake (24) is a rigid and sturdy flat sheet (C_{D}≈100%), horizontally suspended by cables or rigid struts (25) from the turbine (1), wherein the struts allow better use of the brake (24) when the wave is moving downward. The depth at which the brake (24) is located is selected to be about half the average wavelength (wave base) or deeper at the installation site. At this depth the vertical component of water movement is almost zero (FIG. 10). Therefore, the brake (24) at this depth is practically motionless, thus preventing or substantially slowing down the vertical movement of the floating turbine (1) with every passing wave. In this case, the oscillation phase of the turbine (1) lags behind the oscillation phase of the water surface by around 90° to 180°, depending on the braking coefficient. The greater the phase difference, the more wave energy will be transferred to the turbine (1). Therefore, the brake's (24) area should be several times larger than the base area of the double funnel (4) (inlet/outlet opening). The above described shape of the dynamic brake is not meant to be limiting as the other shapes and forms are possible for as long as they serve the specified purpose.

It is also necessary to compensate for the torsional forces of the turbine (1) around its vertical axis caused by the electromagnetic interactions between the stator and rotor of an electric generator while generating electricity, regardless whether the electric generator is a standalone unit (10) affixed to the turbine's frame or housing (16), and whose rotor is connected to the turbine's rotor (2) through the magnetic coupling (9) (preferred embodiment), or the electric generator's stator (23) and rotor (21) are integrated with the turbine's stator (3) and rotor (2) respectively (alternative embodiment). In any case the electric generator transfers its torque to the entire turbine.

In the presence of anchors (18), the torsion force of the turbine (1) is compensated by their static friction force.

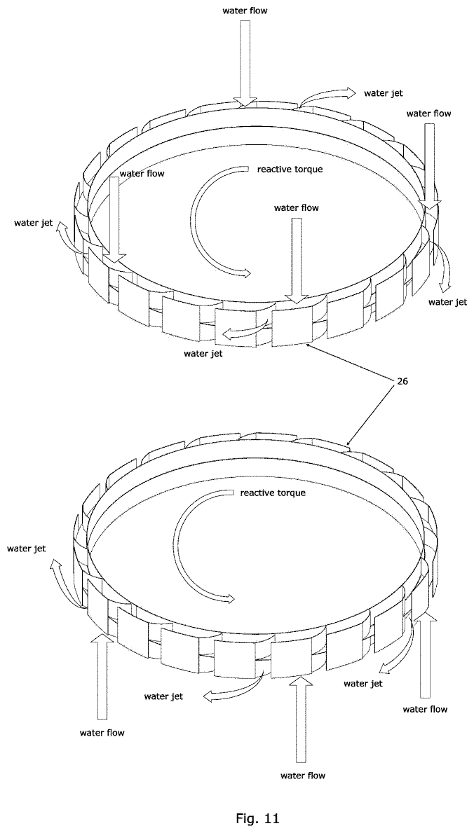

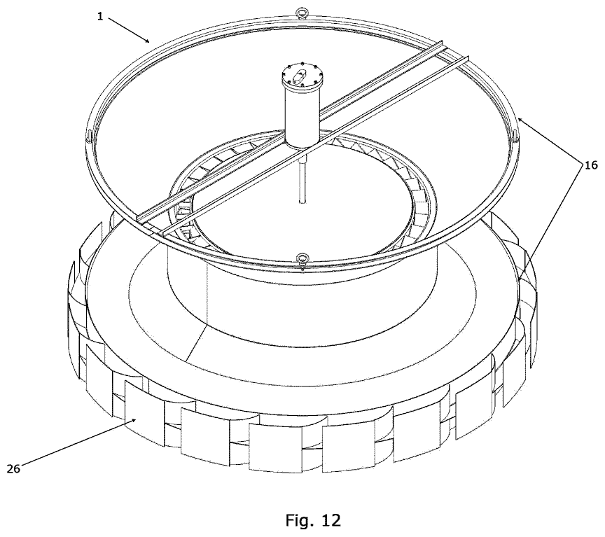

If no anchors are used, then the reactive torque must be used to compensate the hydroelectric turbine's torque. It is therefore proposed to additionally equip the turbine (1) with the reactive turbine (26) (FIG. 11) to be located around the outer circumference of the turbine (1) attached to its housing/frame (16) (FIG. 12). The water flowing outside the turbine, enters the reactive turbine (26) alternately from above and below with the wave action. This is why the reactive turbine (26) is essentially a combination of two mirror-symmetrical turbines with upward and downward-facing water intakes. The water flow tangentially flowing out of the reactive turbine nozzles, creates the reactive torque. This reactive moment created by the reactive turbine (26) compensates for the torsional moment of the hydroelectric turbine (1).

Another way to compensate for the hydroelectric turbine torsional moment is to combine two or more turbines (1) in pairs, providing they rotate in opposite directions. Then the equal but opposite torsional moment of each turbine will neutralize each other without affecting their intended purpose of generating the electricity. Several pairs of turbines can be combined in one assembly, whose dimensions should not exceed ¼ of the average wavelength at the operating site, otherwise the condition of antiphase movement of water and turbines will be violated.

The combination of known technologies and technological solutions in the proposed turbine in a new inventive way made it possible to obtain qualitatively new features that rise to the level of invention:

The turbine efficiency has increased significantly: from 40 to 90% due to the use of a concave-convex profile of the turbine rotor blades.

The peripheral speed of the turbine is increased due to the water pressure on the turbine rotor blades applied in the tangential direction.

The turbine rotor rotates in the same direction regardless of the water flow direction through the turbine due to the two mirror-symmetrical, with respect to the plane of rotation, sets of the turbine stator guide vanes.

The use of the hourglass-shaped double funnel of two identical oppositely oriented hollow truncated cones joined by the hollow cylinder, allows capturing and passing through the turbine significantly more water, multiplying the energy output per unit section of the turbine.

The combination of the double funnel and the narrow channels between the turbine stator guide vanes increased the speed of the water flow passing the turbine rotor blades. Subsequently it increased the rotational speed of the turbine rotor. Increasing the angular speed of rotation has a positive effect on the generation of electricity and reduces the size and weight of the electric generator.

The dynamic brake and the reactive turbine allow the electricity generating turbine to be used without anchoring.

1. A device for converting the energy of a bi-directional reversing water flow, comprising an annular stator with two axially spaced sets of a plurality of guide vanes placed along its circumference that are inclined in the axial direction, an annular rotor with a plurality of concavo-convex blades placed along its circumference with an electric generator attached to it, characterized in that the rotor blades have a profile symmetrical with respect to the plane of rotation, and the angle of attack and the profile of the stator guide vanes are mirror-symmetrical with respect to the plane of rotation of the rotor.

2. The device according to claim 1, characterized in that the rotor is placed to rotate about an axis between the two sets of the stator guide vanes, wherein the stator and the rotor are placed within the cylindrical part of an hourglass-shaped double funnel through which the water flow, caused by the passing ocean waves, passes alternately through its opposite ends, thus when the water passes in one direction, the first end is the inlet, and the opposite end is the outlet, and when the direction of flow reverses, the first end becomes the outlet, and the opposite end becomes the inlet.

3. The device according to claims 1-2, characterized in that it is additionally equipped with a float and attached to a bottom anchor by an anchor rope so stretched that the device is constantly held in an upright position near the water surface enabling the waves pass through the device.

4. The device according to claims 1-2, characterized in that it is additionally equipped with a dynamic brake in the form of a flat body with a large coefficient of hydrodynamic resistance to create a phase difference between the device and vertical oscillations of the waves.

5. The device according to claims 1, 2, 4 characterized in that it is additionally equipped with a reactive turbine, the torque of which is directed in the direction opposite to the torque of the electric generator in order to compensate it and prevent the entire device from spinning.
